(19) United States
(12) Patent Application Publication
(10) Pub. No.: US 2009/0254947 A1
(43) Pub. Date: Oct. 8, 2009

(54) METHOD FOR PROVIDING INTERACTIVE MENUS UPON REQUEST TO TERMINALS COUPLED TO A COMMUNICATION NETWORK

(76) Inventors: Sylvain Squedin, Bondoufle (FR); Serge Papillon, Paris (FR); Olivier Martinot, Draveil (FR)

Correspondence Address: SUGHRUE MION, PLLC, 2100 PENNSYLVANIA AVENUE, N.W., SUITE 800, WASHINGTON, DC, 20037, US

(21) Appl. No.: 12/095,451

(22) PCT Filed: Nov. 27, 2006
(86) PCT No.: PCT/FR2006/051235

§ 371 Date: Oct. 8, 2008

(30) Foreign Application Priority Data
Nov. 30, 2005 (FR) 0553645

(51) Int. Cl. H04N 5/445; H04N 7/173

(52) U.S. Cl. 725/61; 725/126

(57) ABSTRACT

A method is dedicated to providing interactive menus upon the request of a user communication terminal (T1), via a two-way communication network (R1). This method consists, when a terminal (T1, T′) is distributing a piece of content transmitted by the network (R1) on a one-way channel, of i) activating a dedicated function in a communication terminal (T1) so as to transmit to the network, over a two-way backchannel, a request requesting the transmission of an interactive menu related to the distributed content, ii) upon the receipt of said request, accessing first memorization means (BD) in which are stored first data related to said distributed content, iii) generating an interactive menu based on at least said first data related to said distributed content, and iv) transmitting said generated interactive menu to said requesting terminal (Ti) via said backchannel of the network (R1) so that it can display it and so that its user can select at least one of the elements it contains.

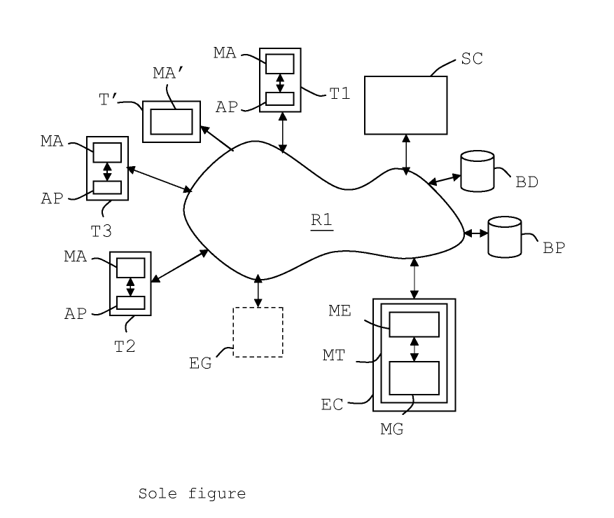

The invention pertains to fixed or mobile communication networks capable of transmitting content and their corresponding interactive menus to communication terminals and so that they may be displayed on their screens.

Here, the term “content” refers to a voluminous set of data defining a television program or a video or audio (radio or musical) program, or games, or multimedia, or a computer file (or “data”).

Furthermore, the term “communication network” here refers to any type of communication network cable of using wires or waves, on so-called “one-way” communication channels, to transmit content to communication terminals coupled to it, and to exchange data or messages on two-way communication channels, known as “backchannels”, with those same communication terminals. Any content transmission mode may be envisioned, in particular unicast mode, multicast mode, or broadcast mode. For example, the network may be a fixed communication network that includes medium- or high-speed two-way data transmission lines, such as cable (or optic fibers) or xDSL lines, or a mobile (or cellular) telephony network, potentially one using satellite relays.

Furthermore, here, the term “communication terminal” refers to any type of communication device capable of receiving content from a network of the above-mentioned type, and of exchanging data, messages, and requests with that same communication network. It may, for example, be a mobile (or cellular) telephone, a personal digital assistant (or PDA), a decoder for encrypted video or television programs, a “set-top box” for receiving television programs, a device receiving video or music programs, or a desktop or laptop computer, or an onboard device in a vehicle (car, truck, bus, train, and similar vehicles).

Some content distributors wish to interact with their clients in order to make available additional information and/or features related to the content that they transmit to them, and/or to learn their opinions about that content. To do so, the distributors integrate interactivity data into the content data that they transmit to their clients, which offer interactive services, potentially in the form of menus, at preset times. In this manner, a client who is watching (or listening to) content received using his terminal over the communication network to which is coupled may be invited by a specific message shown at a given moment to respond to a poll, download a telephone ringtone or a work of film or music, or watch a slow-motion replay.

This interactive mode has at least three disadvantages: firstly, it forces interactive messages onto clients while the content is being broadcast, which may be an annoyance; secondly, it only makes the interactive services available to clients at preset times, and not when they really want or need them; and thirdly (and less importantly) it only offers interactive services which are supposed to correspond to a profile of the average client, and not personalized services.

Thus, the purpose of the invention is to improve the situation, by making it possible to provide clients of content distributors with interactive, and potentially context-based, menus, upon their request and whenever they want them.

For this purpose, it discloses a method dedicated to providing interactive menus upon request from a user communication terminal, over a two-way communication network.

This method is characterized by the fact that, when content transmitted by the network is distributed by a terminal on a one-way channel, it consists of:
i) activating a dedicated feature in communication terminal (potentially a different one from a one distributing it) so as to transmit over the network, via a two-way backchannel, a request to transmit an interactive menu related to the displayed content,
ii) accessing, when this request is received, first memorization means, which store the first data related to the displayed content,
iii) generating an interactive menu for at least the first data related to the displayed content, and
iv) transmitting said generated interactive menu to the requesting terminal over the network backchannel so that the terminal can display it and so that the user can select at least one of the elements it contains.

The method of the invention may include other characteristics, which may be taken separately or in combination, in particular:
in step i), the requesting terminal may integrate an identifier representing the displayed content into the request. In one variant, whenever the content is transmitted live and in unicast mode to the requesting terminal (which, in such a case, is also the distributing terminal), step ii) may also include determining an identifier representing the transmitted content.
in step i), the requesting terminal may integrate an identifier representing its user into the request. In one variant, whenever the content is transmitted to the requesting terminal (which, in such a case, is also the distributing terminal) live and in unicast mode, step iii) may also include determining an identifier representing the user of the requesting terminal.
   in step iii), second memory means may be accessed for extracting information about the user denoted by the user identifier (such as his user profile) from second data; next, the interactive menu may be generated based on the first data, taking the second data into account;
in step iii), the interactive menu may be generated based on the first data, taking into account a piece of time information representing the moment when the request for the displayed content was transmitted;
   when content transmitted live to the requesting terminal (which is then the distributing terminal) is displayed, the time information may be determined in step iii), with said information being the time when the request was transmitted by the requesting terminal;
   in one variant, the requesting terminal may integrate the time information into the request, in step i). In this case, whenever the content had previously been transmitted to the requesting terminal (which, in such a case, is also the distributing terminal), and is then stored therein, the time information represents the elapsed time since the beginning of the displaying of the content, whereas whenever the content was transmitted live to the requesting terminal, the time information is the moment when the request was generated.
at least some of the first data may be edited and/or updated roughly live;
the screen of the requesting terminal can display third data representing an interactive menu for the content being made available to the user. For example, the third data may be displayed for a period of time immediately prior to the beginning of the distribution of the content, or during at least one chosen period of time during the distribution of the content;
it may include a step v) in which the request in terminal transmits a message including the designation of each element selected by the user in the menu, and a step vi) in which the content of the message transmitted is processed in such a way as to meet a request from the user and/or to save information extracted from the transmitted message;
steps ii), iii) and vi) may be carried out in a communication device (such as a server) connected to a communication network.

The invention also discloses a communication device intended to be coupled to a two-way communication network, and comprising processing means that, whenever they receive a request transmitted by a requesting terminal on a two-way backchannel and that request the transmission of an interactive menu related to the content distributed by a terminal (potentially different from the requesting terminal), are tasked with i) accessing first memorization means in which are stored first data related to the distributed content, and then ii) generating an interactive menu based on at least the first data related to the distributed content, and iii) initiating the transmission of the interactive menu to the requesting terminal via the network backchannel, so that it can display it and so that the user can select at least one of the elements it contains.

The communication device of the invention may include other characteristics, which may be taken separately or in combination, in particular:
for distribution by the requesting terminal of a piece of content transmitted live and in peer-to-peer mode, its processing means may be tasked with determining an identifier that represents the transmitted content. In one variant, the request may directly include an identifier that represents the transmitted content;
its treatment means may be tasked with accessing second memorization means to extract second data that represent information about the user denoted by a user identifier, then to generate the interactive menu based on the first data and taking into account the second data;
   when the requesting terminal is distributing content live and in peer-to-peer mode, its processing means may be tasked with determining an identifier representative of the user of the requesting terminal. In one variant, the request may directly contain an identifier representing the user of the requesting terminal;
its processing means may be tasked with generating the interactive menu based on first data and taking into account a piece of time information representing the moment when the request was transmitted with respect to the content broadcast;
   when the requesting terminal is distributing content transmitted live, its processing means may be tasked with determining the time information, said time information being the time when the request was transmitted by the requesting terminal. In one variant, the request may directly include the piece of time information;
if a message transmitted by the requesting terminal is received, and said message includes the designation of each element selected by its user in the menu, its processing means may be tasked with processing the contents of the message received in such a way as to meet a request from the user and/or to save the information extracted from the message received.

Other characteristics and advantages of the invention will become clear upon examining the detailed description below, and the attached drawing, in which the sole figure schematically and functionally depicts a communication network to which is coupled a content server, and an example embodiment of a communication device dedicated to generating interactive menus upon the request of communication terminals. The attached drawing may not only serve to complete the invention, but may also contribute to defining it, if need be.

The purpose of the invention is to make it possible to provide communication terminals, which make such requests during which they display content received via a communication network, with interactive menus related to said content in real time.

In what follows, for the purposes of a non-limiting example, the communication terminals will be considered mobile (or cellular) telephones connected to a mobile (or cellular) telephony network, such as a UMTS network (or a variant or equivalent thereof), and capable of receiving content, such as videos, television programs, or radio programs, over said network. However, the invention is not limited to this type of communication terminal. In fact, it pertains to all types of communication terminals, all types of networks, and all types of content defined in the introduction.

The invention is actually independent of the type of content distributed, and only the details of its implementation depend on the transmission mode of the content.

The single figure depicts a (communication) network R1, to which are connected communication terminals Ti (here i=1 to 3, but it may take on any nonzero value), and potentially at least one content distribution terminal T′ (such as a television set or an MP3 player).

The invention also discloses a method that makes it possible, whenever a terminal distributes a piece of content transmitted by a (two-way communication) network R1, over a “one-way” channel, to provide a communication terminal Ti, which belongs to a client of this network R1 and which is also either the distributing terminal or different from the distributing terminal T′ but is located in its immediate environment, upon its request and via the network R1, with an interactive menu related to this content. The content is transmitted by a content server SC that belongs to a content distributor, which is not necessarily the operator of the network R1.

This method includes at least four steps.

The first step consists of activating, upon the request of a user, a dedicated function in a communication terminal, for example T1, potentially one different from the one distributing the content transmitted to the network R1 on a one-way channel, in order to transmit to network R1, over a two-way “backchannel,” a request requesting the transmission of an interactive menu related to the content displayed.

It is important to note that the invention applies to a first situation in which a distribution terminal T′ receives or has received a piece of content that it is distributing at a given moment and a communication terminal Ti, said to be a requesting terminal and a neighbor of the distribution terminal T′, generates requests related to the content distributed by the distribution terminal, and also to a second situation in which a communication terminal Ti receives or has received a piece of content that it is distributing at a given moment and generates requests related to the content it is distributing. Only a communication terminal Ti, which may also potentially handle the distribution of content, can generate requests, and therefore be termed a requesting terminal.

Furthermore, it is also important to note that the content distributed may be audio and/or visual (such as television programs, video, or data). In the following, it will be assumed for the purposes of a non-limiting example that the distributed content is visual, and consequently, the content is distributed by being displayed on a screen MA for a communication terminal Ti, or a screen MA′ for a distribution terminal T′.

It may be activated at any time, upon the initiative of the user of the requesting terminal T1, inasmuch as the content is being displayed on screen MA of the requesting terminal T1 or on screen MA′ of the distribution terminal T′.

It is important to note that displaying a piece of network on the terminal's screen may also be done live, i.e. at the same time that the network is distributing the content, or on a delay, i.e. once it has been transmitted by the network R1 and then stored in a memory of terminal Ti or T′.

To enable this activation, a requesting terminal Ti must be equipped with an application AT dedicated to providing interactive menus. This application preferably comes in the form of a software module, which may potentially be downloaded upon the request of the user or by the operator of the network R1, or may be installed when the requesting terminal is being manufactured, such as inside the media reader (which then forms an integral part of).

This dedicated application AP is controlled by a key on the requesting terminal Ti or by selecting an element from a menu or sub-menu, or by a voice command.

When the dedicated application AP has been activated, it generates a request requesting the transmission of an interactive menu related to the content which is being displayed on the screen MA of the requesting terminal Ti or the screen MA′ of the distribution terminal T′.

The dedicated application AP may integrate an identifier representing the content that is being displayed into this request. This is mandatory whenever the content is displayed on a delay, i.e. after having been transmitted to the requesting terminal Ti and then stored therein, or whenever multiple pieces of content are transmitted at once in broadcast or multicast mode. In all other situations, there is only one option, given that it is possible to determine the identifier of the distributed content, which therefore is being displayed, by consulting with a content distributor. Whenever the content is distributed by a distribution terminal T′, it is the use of the requesting communication terminal Ti who must indicate to the dedicated application an identifier representative of the content being displayed.

The dedicated application AP may also integrate into the request an identifier representing the user of the requesting terminal Ti in which it is installed. This is mandatory whenever the content is displayed on a delay, or whenever the content is transmitted in broadcast or multicast mode, or whenever the content is distributed by the distribution terminal T′ and not by the requesting terminal Ti. In all other situations, there is only one option, given that it is possible to determine the identifier of the user of the requesting terminal Ti which is transmitting the request via one of its backchannels by consulting with the network R1.

The dedicated application AP may also integrate a piece of time information into the request representing the moment when it was transmitted with respect to the content being displayed. In certain embodiments of the invention, which will be referred to again later, whenever the content is displayed on a delay, this integration is necessary, given that a remote device cannot determine how much time has passed since the beginning of the distribution of the content on the screen MA of the requesting terminal Ti or the screen Ma′ of the distribution terminal T′. In such a case, the piece of time information may represent, for example, the amount of time that has passed since distribution began. In all other situations, there is only one option, given that it is possible to determine the moment the request was generated, which roughly corresponds with the portion of the content that is being displayed.

Each request is intended to be processed by a communication device EC which is coupled to the network R1 (but which is not necessarily a part of it) and which has an address. This communication device EC may, for example, come in the form of an application server.

It is important to note that multiple communication devices EC may be designed, each dedicated to one type of content, or to one content distributor. In deed, it may be foreseen that a first communication device is dedicated to processing requests related to video content, that a second communication device is dedicated to processing requests related to television program content, and that a third communication device is dedicated to processing requests related to audio or radio program content.

When multiple communication devices EC are coupled to the network, but the applications AP installed in the requesting terminals Ti only have a single address to transmit their requests, an additional communication device EG may be included, tasked with collecting all requests and with analyzing them in order to determine which communication device EC should process each of them.

The second step begins whenever a communication device EC receives a request from a requesting terminal Ti.

This second step consists of accessing first memorization means BD, in which are stored first data related to all content processed by the communication device EC which is the intended recipient of the request, in order to extract from them all of the first data related to the content displayed by the requesting terminal Ti (or the distribution terminal T′).

To do so, each communication device EC has a processing module MT tasked with processing the requests it receives. More precisely, the processing module MT must first determine the identifier of the content which is being requested by the received request. As indicated above, this content identifier may be part of the request. Otherwise, the processing module MT must determine it by consulting with the content distributor (which is not possible when the requesting terminal is also the one which distributes the content).

Once the processing module MT has the identifier of the content, it loads an extraction module ME, which it includes, in order to access the first memorization means BD in order to extract from them the first data related to the identified content.

It is important to note that the first memorization means BD are not necessarily part of the communication device EC. This is particularly true in the example illustrated in the sole figure. It includes information that is provided, edited, and updated by the content distributor(s). Consequently, the first memorization means BD may be installed on a device of the content distributor, such as on its content server SC. The important thing is that they are accessible to the communication device EC via the network R1.

These first memorization means BD may come in any form, particularly in the form of a memory or a database.

Furthermore, the first data may be of any type, as long as they are related, even distantly, with the distributed content, for their distributor. For example, for a sports program, such as a soccer game, the first data may be information related to the players and coach, strategies commonly used by the coach, or information about the teams that are playing (and potentially about all other teams in the same league or in foreign leagues), and particular about their respective records, their respective game results since the beginning of the season, and their next game(s). Furthermore, whenever the first data can be edited and/or updated, it may consist of images of sequences that just played themselves out, in order to offer slow-motion replays.

Whenever the content is musical, the first data may, for example, be information about the orchestras, singers, or bands whose works are being distributed by the content distributor, and particularly their discographies or the dates and venues of their upcoming concerts, or ways to download at least one of their recordings for a fee.

Once the extraction module ME has extracted all of the first data related to the content being requested, it may communicate them, for example, to a generation module MG of the processing module MT tasked with implementing the third step of the inventive method.

This third step consists of generating an interactive menu based on at least the first data related to the displayed content (extracted from the first memorization means BD).

In this third step, the generation module MG builds an interactive menu intended for the requesting terminal Ti which transmitted the request, based on the first data related to the content being displayed on its screen MA (or on the screen MA′ of the neighboring distribution terminal T′).

Whenever the processing module MT has a piece of time information representing the moment when the request was transmitted with respect to the content being displayed, its generation module MG may improve or complete the interactive menu. In this case, it may integrated into the interactive menu one or more elements related to the portion of content which has just been displayed on the screen MA of the requesting terminal Ti (or the screen MA′ of the neighboring distribution terminal T′). The interactive menu then becomes contextual. In the abovementioned example of a sports program, one or more slow-motion replays for a play that just occurred (or was just displayed) may be offered in the menu in this manner, seen from one or more different angles, for example.

As indicated above, the piece of time information is either contained within the request, or determined by the processing module MT using a clock synchronized with the content server SC of the content distributor. In the latter case, it identifies the date it received the request with the date the request was generated.

Naturally, in order to be able to use the time information, the second data must be stored in connection with a time (and potentially a date).

Whenever the processing module MT has an identifier for the user of the requesting terminal Ti that transmitted the request, its generation module MG may advantageously construct a personalized (or contextual) interactive menu based on the second data representing information about that user. This second data is stored in second memorization means BP, coupled to the network R1. It may, for example, be user profiles (or portions thereof) stored in connection with their user identifiers.

It is important to note that the second memorization means BP are not necessarily part of the communication device EC. This is particularly true in the example illustrated in the sole figure. They include information which is provided, edited, and updated by the content distributors, or by the operator of the network R1 when they are clients thereof (which is not mandatory). Consequently, the second memorization means BP may be installed on one of the content distributor's devices (such as on its content server SC) or one of the network operator's devices. The important thing is that they are accessible to the communication device EC via the network R1.

These second memorization means BP may come in any form, particularly in the form of a memory or a database.

Furthermore, the second data may be of any type, as long as they are related, even distantly, with the user of the requesting terminal Ti. Thus, it may be the age group, gender, program type preferences, taste, area of interest, hobbies, time slots for viewing programs, and generally speaking, anything that may make it possible to personalize a user. This information about users is generally used by content distributors, particularly to hone viewership analyses or viewership rates.

It should be noted that one element of the contextual interactive menu may potentially call upon a sub-menu intended to offer the user of the requesting terminal Ti actions which are indirectly linked to the content which he is watching (or listening to). In this manner, a submenu may make community information available to a user, such as a list of friends who are watching the same content as him and at the same time, or a list of friends who are located within the same geographic area as him, or the ability to open a chat window with friends.

Naturally, in order to offer such a service, the user profile (or second data) must allow for it, and the friends' identifiers must be stored in the form of second data. Also, the communication device EC must be authorized to access additional information contained within the network cores, such as the geographic locations of the users' terminals.

As indicated above, the identifier of the user of the requesting terminal Ti is either contained within the request, or determined by the processing module MT by consulting with the network R1. In the latter case, the network R1 knows the identifier of the requesting communication terminal Ti, because it transmitted its request via one of its backchannels. It is therefore relatively easy to deduce therefrom the identifier of the user of the requesting terminal Ti, particularly when it is the same identifier as that of said requesting terminal Ti.

Once the processing module MT has an interactive menu (which may be contextual, i.e. personalized or temporally improved), it begins transmitting it over the network R1, in the form of a message being sent to the requesting terminal Ti. This transmission constitutes the fourth step of the inventive method.

Whenever the requesting terminal Ti receives a message from the network via the backchannel previously used to transmit the request (i.e. the same channel), it transmits it to its dedicated application AP. This application extracts the interactive menu and orders the display means of its requesting terminal Ti to display it on the screen MA, such by overlaying it atop the content which is being displayed.

The user of the requesting terminal Ti may then, if desired, selected at least one of the elements contained within the interactive menu displayed on the screen MA.

The method may then continue to a fifth step, in which the dedicated application AP generates a message including the designation of each element selected from the interactive menu by the user of the requesting terminal Ti, then orders said requesting terminal Ti to transmit this message to the communication device EC which transmitted it to the interactive menu, via the previously used backchannel.

Whenever the communication device EC receives the message from the requesting terminal Ti, via the network R1, its processing module extracts the content from it in order to process it. This constitutes the potential sixth step of the inventive method.

More precisely, the processing module MT determines whether the user has made a particular request (with respect to elements contained in the interactive menu), and if so, it performs the operations that will make it possible to meet his request. These operations may, for example, consist of transmitting specific information related to the displayed content, or to establish a connection with another server, such as one tasked with transmitting a musical recording, or one dedicated to paying for purchases. The processing module MT may also record information extracted from the transmitted message into a memory (not shown, and which is not necessarily part of the communication device EC). This information may, for example, be that which is useful to content distributors to conduct or improve viewership analyses or viewership rates.

The processing module MT of each communication device EC of the invention may be constructed in the form of electronic circuits, software (or computer) modules, or a combination of circuits and software.

It should be noted that to familiarize the user with the interactivity, the dedicated application AP may be configured in such a way as to display on the screen MA of its requesting terminal Ti, such as by overlaying it, third data representing the availability of an interactive menu related to the content. For example, this third data may be displayed during an interval of time which immediately precedes the beginning of the displaying of the content on the screen MA, or during one or more selected intervals of time during the period when the content is being displayed.

This third data may, for example, constitute a text or audio message, and/or a logo.

The invention offers some advantages, among which are:
it makes it possible to not have to attach menu data to the content data.
it makes it possible to provide the user of a communication terminal, who is watching a piece of content displayed by a distribution terminal (such as a television set, potentially one installed in a public place), with a menu related to said displayed content, without this disturbing other people who may be watching said content on the same distribution terminal,
it enables users to access interactive menus whenever they want,
it offers independence from transmission modes,
it makes it possible to make new services and applications available to users,
it pertains both to fixed communication networks and to mobile (or cellular) communication networks,
it makes it possible to take contextual information into account (user profiles and/or time-related information).

The invention is not limited to the embodiments of the method of providing interactive menus and the communication device described above, which are only given as an example; rather, it encompasses all variants that a person skilled in the art may envision within the framework of the claims below.

1. A method of providing interactive menus upon the request of a user communication terminal (Ti) over a two-way communication network (R1), in which, when a terminal (Ti, T′) is distributing a piece of content transmitted by said network (R1) on a one-way channel, i) a dedicated function is activated in a communication terminal (Ti) in such a way as to transmit to said network (R1), via a two-way backchannel, a request requesting the transmission of a piece of information related to said distributed content, ii) upon the receipt of said request, first memorization means (BD), in which are stored first data related to said distributed content, are accessed, characterized in that the information requested is an interactive menu, and in that iii) an interactive menu is generated based on at least said first data related to said distributed content, and iv) during the distribution of the content, said generated interactive menu is transmitted to said requesting terminal (Ti) via said backchannel of the network (R1) so that it can display it and so that its user can select at least one of the elements it contains.

2. A method according to claim 1, characterized in that in step i), said requesting terminal (Ti) integrates into said request an identifier representing the distributed content.

3. A method according to claim 1, characterized in that said requesting terminal (Ti) is said distributing terminal, and in that when content transmitted to said requesting terminal (Ti) is transmitted live and in peer-to-peer mode, an identifier representing the transmitted content is determined in step ii).

4. A method according to claim 3, characterized in that an identifier representing the user of the requesting terminal (Ti) is determined and iii) second memorization means (BP) are accessed in order to extract second data representing information about the user designated by said user identifier, then said interactive menu is generated based on said first data and taking said second data into account.

5. A method according to claim 4, characterized in that said second data represents user profiles.

6. A method according to claim 5, characterized in that in step iii), said interactive menu is generated from said first data and taking into account a piece of time information representing the moment when said request was transmitted with respect to the distributed content.

7. A method according to claim 6, characterized in that said requesting terminal (Ti) is said distributing terminal, and that when a piece of content transmitted to said requesting terminal (Ti) is distributed live, said piece of time information is determined in step iii), with said information being the time when said request was transmitted by said requesting terminal (Ti).

8. A method according to claim 1, characterized in that the third data representing the providing of said user with an interactive menu for said content is displayed on a screen (MA) of said requesting terminal (Ti).

9. A method according to claim 8, characterized in that said third data is displayed during a period of time immediately prior to the beginning of the distribution of said content.

10. A method according to claim 9, characterized in that said third data is displayed for at least a selected interval of time during the period when said content is being distributed.

11. A method according to claim 1, characterized in that it comprises a step v) in which said requesting terminal (Ti) transmits a message including the designation of each element selected by its user in said menu, and a step vi) in which the content of said transmitted message is processed in such a way as to meet a request by said user and/or in which information extracted from the transmitted message is recorded.

12. A method according to claim 1, characterized in that steps iI), iii), and vi) are performed in a server (EC) coupled to said communication network (R1).

13. A communication device (EC), capable of being coupled to a two-way communication network (R1), characterized in that it comprises processing means configured, when receiving a request transmitted by a requesting terminal (Ti) on a two-way backchannel on the network (R1) and requesting the transmission of an interactive menu related to content distributed by a terminal (Ti, T′), i) to access first memorization means (BD) in which first data related to said distributed content is stored, and then ii) to generate an interactive menu based on at least said first data related to said distributed content, and iii) to initiate the transmission of said interactive menu to said requesting terminal (Ti) via said backchannel on the network (R1), so that it can display it and so that its user can select at least one of the elements it contains.

14. A device according to claim 13, characterized in that said processing means (MT) are configured, when said requesting terminal is distributing a piece of content transmitted live and in peer-to-peer mode, to determine an identifier representing the transmitted content.

15. A device according to claim 13, characterized in that said request includes an identifier representing the transmitted content.

16. A device according to claim 13, characterized in that said processing means (MT) are configured to access second memorization means (BP) to extract second data representing information about the user denoted by a user identifier, and then to generate said interactive menu from said first data, taking said second data into account.

17. A device according to claim 13, characterized in that said processing means (MT) are configured to generate said interactive menu based on said first data and taking into account a piece of time information representing the moment when said request was transmitted with respect to said displayed content.

18. A device according to claim 13, characterized in that said processing means (MT) are configured, whenever a message transmitted by said requesting terminal (Ti) and including the designation of each element selected by its user in said menu is received, to process the content of said received message in such a way as to meet a request from said user and/or to save information extracted from said received message.
